(19) United States
(12) Patent Application Publication
(10) Pub. No.: US 2006/0162223 A1
(43) Pub. Date: Jul. 27, 2006

(54) Disposable gun barrel cleaning device

(76) Inventor: Gary Stewart Whipple, E. Hardwick, VT (US)

Correspondence Address: Jay P. Friedenson, Esq., 4375 Elmore Mt. Road, Morrisville, VT, 05661, US

(21) Appl. No.: 11/267,634

(22) Filed: Nov. 7, 2005

Related U.S. Application Data
(63) Continuation-in-part of application No. 11/030,861, filed on Jan. 6, 2005.

(51) Int. Cl. F41A 29/00; B08B 1/00

(52) U.S. Cl. 42/95; 15/104.16

(57) ABSTRACT

A disposable cleaning device for the barrel or bore of a gun or firearm is provided which comprises a jag member which is adapted to contain a cleaning fluid for the barrel or bore, which jag member has means at one end for securing to a ram-rod or cable and also has means for allowing the cleaning fluid to contact an absorbent cleaning material. In certain embodiments the absorbent cleaning material surrounds the jag member and is pre-wetted with cleaning fluid or becomes wetted with cleaning fluid after a rupturable means within the jag member containing the cleaning fluid is ruptured or broken. In other embodiments, the jag member includes an internal chamber containing the cleaning fluid sealed with a rupturable or removable membrane or member, which when ruptured or removed, allows cleaning fluid to escape and contact cleaning material which is, or which is brought, in proximity to the chamber. In all the embodiments of the invention the devices have self-contained storage of cleaning fluid and are disposable after a single use.

### CROSS-REFERENCE TO RELATED APPLICATION

This application is a continuation-in-part of U.S. application Ser. No. 11/030,861, filed Jan. 6, 2005 by the same inventor, Gary Stewart Whipple.

### BACKGROUND OF THE INVENTION

This invention relates to a disposable cleaning device for gun barrels or firearms.

Firearms or guns, once discharged, must be cleaned frequently to remove various contaminants formed by combustion and oxidation processes. Frequent cleaning is particularly desirable with muzzle-loaded guns where cleaning is indicated after only several shots, but is also important with rifles and other firearms.

A variety of cleaning devices for firearms have been disclosed, but generally they are all complex, comprised of many parts, cumbersome to carry into the field and use, are expensive to purchase and are not disposable.

Typically, in the field, a user of a firearm must carry separate supplies including a ram-rod with a jag (for pushing cleaning material through a gun bore) or a cable with jag (for pulling cleaning material through a gun bore), a cleaning solvent (which is usually carried in bottles or other containers) and absorbent cleaning patches which must be saturated with the solvent in one step and then, in separate steps, be attached to the jag on the ram-rod or cable and then pushed or pulled through the bore of the gun. The difficulties and disadvantages of saturating a cleaning patch with cleaning solvent in a separate step from a cleaning solvent container are well known in the art and are discussed in detail in U.S. Pat. No. 6,023,873 (col. 1, lines 16-38), which discussion is hereby incorporated by reference.

Further, sometimes one of the cleaning implements is forgotten, such as the cleaning solvent or the absorbent patches, or the container containing the cleaning solvent is accidentally broken or lost under conditions of handling and use in the field. This cleaning system is not disposable, that is to say that the cleaning solvent container and absorbent patches must be stored separately and brought to the field for each occasion of use.

Various devices have been proposed to solve these problems, some of which include devices with internal cleaning solvent storage and dispensing means; however, the prior art devices are complex, contain a multitude of components, are expensive and are not disposable.

The object of my invention is to provide a simple, inexpensive and disposable device for cleaning the bores of firearms or guns which does not suffer from the above-described disadvantages.

As will be described in more detail hereafter, the above-stated object of my invention (and others) are accomplished by providing a disposable, inexpensive and easy to use device for cleaning gun bores which has the cleaning solvent internally contained.

In certain embodiments of my invention, the device also incorporates the absorbent cleaning material thereby obviating the need for the user to bring absorbent cleaning material separately for use.

In other embodiments of my invention, absorbent cleaning material is brought separately, but because of the unique design of my invention, is easier to saturate or use with the cleaning solvent while minimizing the problems encountered in the prior art.

### SUMMARY OF THE INVENTION

My invention is directed to a disposable cleaning device for a firearm or gun barrel or bore which comprises a jag member which is adapted to contain a cleaning fluid for the gun barrel. The jag member has means at one end for securing to a ram-rod or cable and further has means for allowing the cleaning fluid to contact an absorbent cleaning material.

The invention has several non-limiting embodiments.

In one embodiment, the user causes self contained cleaning fluid in a jag member to be released in contact with an absorbent cleaning material by rupturing or removing a means for containing such cleaning fluid, thereby allowing the fluid to come into contact with absorbent cleaning material which is either attached to the jag member or which is brought into contact with the released cleaning fluid.

In another embodiment, the user removes a readily removable seal around a jag member which has a wrapper of an absorbent cleaning material which surrounds and is secured to the jag member, which absorbent cleaning material has been saturated with cleaning fluid. The seal serves to seal the jag member from the atmosphere to prevent premature loss by evaporation of the cleaning fluid.

In all of the embodiments of the invention, the jag member has means for ready attachment to a ram-rod or cable which is then used to clean the bore of a gun and is disposed of after a single use.

The devices of the invention thus contain cleaning fluid, are inexpensive to manufacture, are easy to use and are disposable after a single use.

### BRIEF DESCRIPTION OF THE DRAWINGS

FIG. 1A is a perspective view of one embodiment of the invention wherein a disposable jag member is wrapped with absorbent cleaning material which has been saturated with cleaning fluid which is sealed from the atmosphere with a readily removable material which readily removable material is shown partially removed.

FIG. 1B is a longitudinal cross section of the embodiment of FIG. 1A along the section line 1B-1B of FIG. 1A with the readily removable material intact.

FIG. 1C is a cross section of the embodiment of FIG. 1A along the section line 1C-1C of FIG. 1B with the readily removable material intact.

FIG. 2A is a perspective view of another embodiment of the invention where the disposable jag member is wrapped with absorbent cleaning material and contains a rupturable capsule for cleaning fluid which is in open communication with the absorbent cleaning material.

FIG. 2B is a cross section of the embodiment of FIG. 2A along the section line 2B of FIG. 2A.

FIG. 2C. is a partial longitudinal cross section of the embodiment of FIG. 2A showing elongated openings in the sidewall of the jag member.

FIG. 3A is a side elevation view of another embodiment of the invention where the disposable jag member has a chamber containing cleaning fluid which is sealed with a rupturable membrane. This figure shows a detachable plunger affixed to the jag member which can be used to puncture the rupturable membrane.

FIG. 3B is an exploded perspective view of the embodiment of FIG. 3A showing the plunger in detached position ready to be inserted through a patch of absorbent cleaning material into the chamber containing cleaning fluid.

FIG. 3C is a partial longitudinal section view of the embodiment of FIG. 3B with the plunger inserted through the patch of absorbent cleaning material and through the rupturable membrane into the chamber.

FIG. 4 is another embodiment of the invention which is similar to the embodiment of FIG. 3A in which the body of the disposable jag member has a curved stepped down portion.

FIG. 5 is another embodiment of the invention in which the body of the disposable jag member has a graduated stepped down portion.

FIG. 6 is another embodiment of the invention in which the body of the disposable jag member has a multiplicity of angled ribs of reduced diameter and a stepped down portion adjacent to the means for securing the jag to a ram-rod or cable.

FIG. 7 is another embodiment of the invention in which the body of the disposable jag member has a multiplicity of flexible fins and a stepped down portion adjacent to the means for securing the jag to a ram-rod or cable.

### DETAILED DESCRIPTION

All of the embodiments of the invention show disposable cleaning devices for a gun barrel comprising a jag member which is adapted to contain a cleaning fluid for the gun barrel, which jag member has means at one end for securing to a ram-rod or cable and further has means for allowing the cleaning fluid to contact an absorbent cleaning material.

For the purpose of the description herein, “jag member” refers to an object or manufacture which holds or, to which is attached, absorbent cleaning material, which object may then be easily attached to a ram-rod or cable for pushing or pulling through the barrel or bore of a firearm or gun. The absorbent cleaning material is wetted with cleaning fluid so that the action of pushing or pulling the jag member through the bore of the firearm serves to clean the internal surface of the bore. The size of the jag member is so dimensioned so as to fit within the caliber of the firearm to be cleaned.

The cleaning fluid may be any of the well known cleaning fluids known to the art to be useful for cleaning lead and copper fouling, as well as propellant and carbon fouling. Illustrative of such fluids are aqueous detergent solutions, ammonia solutions and trichloroethylene based solutions. The identity of the particular cleaning fluid chosen is not critical to the invention claimed herein.

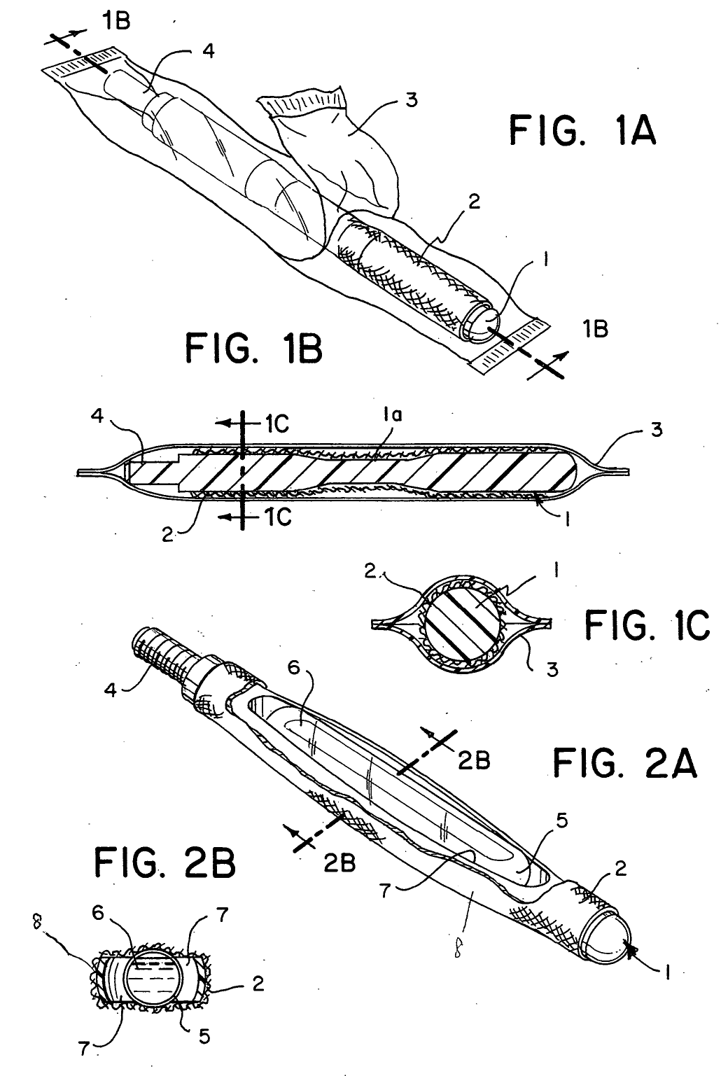

In the embodiment illustrated in FIGS. 1A, 1B and 1C, the means for allowing the cleaning fluid to contact the absorbent cleaning material comprises an absorbent cleaning material containing the cleaning fluid secured to the jag member which absorbent cleaning material is sealed to the atmosphere with a readily removable material such as, for example, a plastic wrapping or a rupturable plastic cover. In the embodiment shown in these figures, jag member 1 is preferably cylindrical in configuration and is wrapped with absorbent cleaning material 2 which preferably surrounds the jag member. Absorbent cleaning material 2 preferably surrounds jag member 1 along a substantial portion of its' longitudinal axis. Preferably jag member 1 has a portion 1a of restricted diameter between its' extremities. This serves the purpose of providing a relief or flexibility in the jag member to facilitate its' use in a cleaning mode. However, the restriction in the jag member should not be so severe as to cause it to break in cleaning mode. Generally, the restriction should be a reduced diameter from about ¼ to ⅓ of the diameter of the jag member.

Normally, the wrapping of the absorbent cleaning material around the jag member secures the absorbent cleaning material to the jag member but, if desired, the absorbent cleaning material may be further secured to the jag member, such as by tying or with an adhesive. The absorbent cleaning material may be any of the well known materials used in the art for this purpose including various cloth materials such as cotton and various paper products. The only requirement is that the cleaning material be able to absorb and retain the cleaning fluid.

In the embodiment of FIGS. 1A, 1B and 1C, cleaning material 2 has been wetted, preferably saturated, with cleaning fluid. The wetted cleaning material 2 is sealed from the atmosphere to prevent premature drying out of wetted cleaning material 2 by evaporation before use. This may be accomplished by any convenient means such as an airtight container such as a plastic tube which may be equipped with a removable cap (not shown in the drawings) or a wrapping material 3 as shown in FIGS. 1A, 1B and 1C. The wrapping material may be constructed of any suitable material, such as a plastic film, for example, polyethylene film. In the embodiment of FIGS. 1A, 1B and 1C, the wrapping material is configured as an envelope surrounding the entire jag member; however, said wrapping material may be configured in other ways such as, for example, surrounding the wetted cleaning material only. The only requirement for the wrapping material configuration is that it seals the wetted absorbent cleaning material from the atmosphere, thereby preventing the wetted absorbent cleaning material from drying out before use.

As in all the embodiments of the invention, jag member 1 of the embodiment of FIGS. 1A, 1B and 1C has means at one end for securing the jag member to a ram-rod or cable. Such means is most conveniently a male threaded portion 4 of reduced diameter as shown in FIGS. 1A and 1B which mates with a female threaded end of a ram-rod or cable. Other connecting means may be used, such as locking lug members, but threaded connecting means are most convenient since ram-rods and cables suitable for gun cleaning are sold with standard female threaded connections for this purpose. Male threaded portion 4 need not screw directly into a female threaded end of a ram-rod or cable; it may if needed or desired be threaded through an adaptor (not shown) which mates with the ram-rod or cable. Male threaded portion 4 is not wrapped with absorbent cleaning material.

The jag member is preferably constructed of a flexible material such as a flexible plastic material so as to facilitate the jag member to be pulled (in the case of a cable connection) around a curve or corner, as may occur in the case of rifle bores where there are no breach plugs. The size, that is to say, diameter of the jag member must be such as to fit into the caliber of the bore or barrel of the particular gun or firearm to be cleaned and thus the jag members would be manufactured in different sizes to accommodate the different calibers of the firearms to be cleaned. The jag size to be used must allow for a snug fit between the cleaning material and the inner surface of the gun bore to allow for efficient cleaning, but not so snug as to inhibit the jag member from being pushed or pulled through the gun bore in a smooth stroke or strokes. This may be easily determined for each candidate gun caliber by one of ordinary skill in this art. For example, in the case of a 30 caliber rifle bore, the jag outer diameter of the preferred cylindrical configuration, excluding the absorbent cleaning material wrapping, should be about 0.26 inch. A typical length for the jag member in this embodiment would be about 2 inches with about 0.3 inch allowed for threaded male portion 4 which may be of a reduced diameter from the main body of the jag member to allow for the overlapping portion of the ram rod. A jag member would be chosen such that its' threaded male portion 4 would fit within the female threaded end of a suitably sized ram-rod or cable for the caliber of gun to be cleaned. Typically, threaded male portion 4 is equipped with 10/32 threads. In some cases the threaded male or connecting portion 4 may be threaded into an adaptor which, in turn, may be threaded into the female threaded end of the ram-rod or cable.

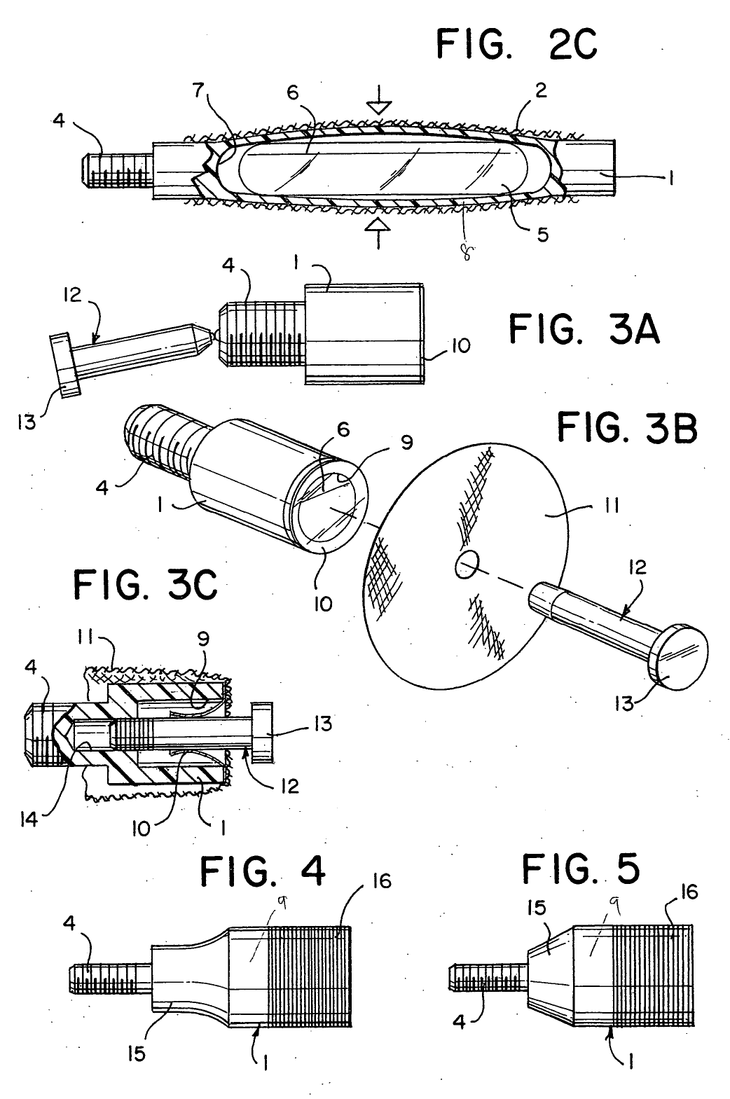

In the embodiment of FIGS. 2A, 2B and 2C, the means for allowing the cleaning fluid to contact the absorbent cleaning material comprises rupturable means 5 within jag member 1 containing cleaning fluid 6, means for the cleaning fluid to escape from the jag member upon rupture of rupturable means 5 and an absorbent cleaning material 2 in contact with, but preferably secured to the outer surface of jag member 1. Thus, upon rupture of the rupturable means 5, cleaning fluid 6 escapes from rupturable means 5 and is absorbed by absorbent cleaning material 2. If it is desired to secure the absorbent material to the outer surface of the jag member, such may be accomplished by any convenient means such as by tying or with an adhesive.

Rupturable means 5 may be any convenient containment within the jag such as a breakable or rupturable capsule which may be constructed of, for example, a plastic or a glass material. Any one of a number of means may be employed for allowing the cleaning fluid which escapes from the ruptured rupturable means 5 to contact and be absorbed by absorbent material 2. For example, jag member 1 containing rupturable means 5 may be in open communication with absorbent cleaning material 2. For example, such open communication may be provided by perforations (not shown) in jag member 1 so that when rupturable means 5 is ruptured or broken, cleaning fluid escapes through the perforations and contacts and is absorbed by absorbent cleaning material 2.

In the preferred embodiment shown in FIGS. 2A, 2B and 2C, such open communication is achieved by providing elongated openings 7 in the sidewalls of jag member 1. The elongated openings 7 are best shown in FIG. 2C. Jag member 1 and rupturable means 5 are mutually sized so that rupturable means 5 fits within jag member 1. Preferably, for ease of manufacture, the sizing is such that rupturable means 5 may be inserted into jag member 1 through either of its' elongated openings (6). Otherwise, the sizing of the elongated openings 7 is not critical and the optimum sizing may be determined by routine experimentation. The jag member containing rupturable means 5 may then be wrapped as desired with absorbent cleaning material 2. In use, rupturable means 5 is caused to rupture or break whereupon cleaning fluid is released and wets cleaning material 2. The cleaning device is now ready for use and may be attached to a ram-rod or cable by means of threaded male portion 4 and used for cleaning as described previously. After use, the device is discarded.

In a still preferred embodiment of FIGS. 2A, 2B and 2C, jag member 1 is constructed so as to be flexible. This may be accomplished, for example, by using a soft or flexible plastic material or by providing relatively thin walls 8 of whatever material of construction in jag member 1. This serves the purpose of facilitating rupture of rupturable means 5 by compressing or twisting jag member 1 and also allows for easier movement of the jag member within a gun bore when it is necessary to turn or bend the jag member to facilitate its' entry or removal from the gun bore.

Typical sizing and dimensions for this embodiment of the invention are the same as described for the embodiment of FIG. 1a.

In the embodiment shown in FIGS. 3A, 3B and 3C, the means for allowing said cleaning fluid to contact absorbent cleaning material comprises a chamber 9 inside and at the end of jag member 1 which contains cleaning fluid 6. Chamber 9 is located opposite means 4 for securing jag member 1 to a ram-rod or cable. Chamber 9 has a rupturable or removable membrane or member 10 at the end of the chamber sealing the chamber to prevent premature release of cleaning fluid. Upon rupture or removal of membrane or member 10, cleaning fluid escapes, or can be released, from chamber 9 to contact absorbent cleaning material 11 which is brought in proximity to chamber 9. If member 10 is as rupturable membrane, it may be constructed of any suitable material, such as a plastic film or a metallic foil, such as aluminum foil. If member 10 is a removable member, it may be any readily removable closure including, but not limited to, a peelable membrane or cap, or a cap which can be pried or pulled off, for example, with the aid of a pull-tab, or a cap which can be removed by pressing in. Any other means for accomplishing the same purpose of unsealing the chamber closure to allow escape of cleaning fluid may be employed. Other such means may readily be devised by persons skilled in the art and such means per se are not part of this invention.

The method of effecting the seal with a membrane or cap is also not part of this invention and may be achieved in any convenient manner by those skilled in this art. Illustrative techniques for sealing include induction or heat sealing or gluing. The sealing material must, of course, be non-reactive with the cleaning fluid. Polyethylene is generally suitable for this purpose.

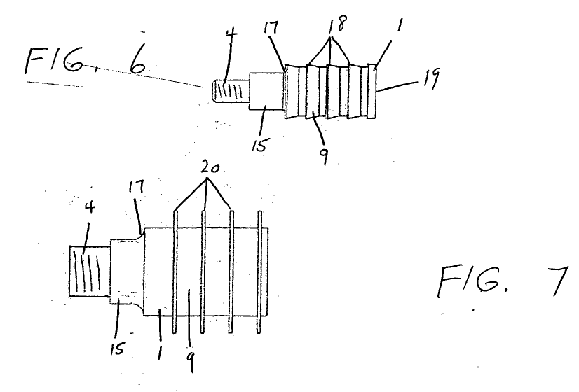

Referring to FIGS. 3B and 3C, in operation of this device, absorbent cleaning material is provided in the form, for example, of a patch 11 through which a plunger 12 is passed. The plunger has an enlarged head 13 to prevent patch 11 from slipping off the plunger. Plunger 12 with absorbent material patch 11 attached is then used to puncture member 10 which, in this embodiment, is a rupturable membrane, and plunger 12 is inserted into chamber 9. Cleaning fluid 6 escaping from chamber 9 then wets the absorbent material and the device is now ready for use and may be attached to a ram-rod by means of threaded male portion 4 and be used for cleaning a firearm muzzle or bore as described previously. In operation, the absorbent material is compressed between jag member 1 and the gun bore (not shown). Such compression tends to hold the absorbent material onto the jag member around the outside of chamber 9 (sometimes referred to as the head portion of jag member 1). If desired, in order to enhance the retention of the absorbent material on the jag head, the head may be adapted with means to assist in preventing slippage of the absorbent material off the jag head. Such means may comprise threads or knurls or other distressed areas on the jag head, or ribs or fins which will accomplish the same function. Other means to accomplish this function will occur to persons skilled in the art. Such means in the form of threads 16 on the jag head are illustrated in the embodiments shown in FIGS. 4 and 5.) After use, the device is discarded.

When plunger 12 containing patch 11 is inserted into chamber 9, a portion of patch 11 is pushed into the chamber. Generally, the resulting fit between the patch and the chamber is sufficient to prevent the plunger and patch from becoming detached from the jag member. If that should occur, there is a possibility that during use plunger 12 might become detached from patch 11 and stay in the gun barrel. This could cause a problem in the event that the gun barrel were loaded with the plunger inside. One way to prevent this from happening would be to provide a step-down (not shown) on the shaft of plunger 12 to engage patch 11 and prevent it from falling off the plunger shaft at the opposite end from the plunger head.

In a preferred embodiment, however, means is provided to enhance the retention of plunger 12 in chamber 9. This embodiment is shown in FIG. 3C in which a recess 14 is provided within and at the bottom of chamber 9. This recess 14 is of a shape and dimension to provide a seat for the end of plunger 12. The seat is snug so as to provide a friction fit. In this embodiment, plunger 12 with attached patch 11 is inserted into chamber 9 and into recess 14. This provides a secure fit for the plunger so as to diminish the possibility that the plunger may become detached from the jag member during use. If desired, the bottom end of plunger 12 may be threaded (not shown in the drawings) to provide a screw fit into receptive threads in recess 14.

In the preferred embodiment of the invention shown in FIG. 3B, plunger 12 is removably attached to the end of jag member 1 which comprises the means for securing jag member 1 to a ram-rod. That is to say that plunger 12 is removably attached to the end of threaded male portion 4 of jag member 1. Removability of plunger 12 may be accomplished by any convenient means such as by connecting plunger 12 to the end of threaded male portion 4 in such a way that it can easily be broken or snapped off and separated from threaded male portion 4. This can be accomplished with a small amount of glue or other convenient means, or manufactured in the form of a snap-off plunger member. This feature makes the device convenient for use by making the plunger readily available and minimizes the need for the user to keep track of the separate parts needed for use of the device.

Illustrative dimensions for the jag member according to embodiment of FIGS. 3a, 3b and 3c of the invention for use with a 45 caliber muzzleloader are as follows: The overall length of jag member 1 may be 1.1 inches including the threaded ( 10/32) male portion 4. The length of the jag member 1 without the threaded male portion 4 may be 0.8 inch making the length of the threaded male portion 0.3 inch. The jag member is cylindrical with an outer diameter of 0.4 inch. The internal diameter of chamber 9 may be 0.32 inch. In this embodiment, recess 14 would typically have a diameter of about 0.151 inch to receive a plunger having a diameter of about 0.150 inch. Plunger head 13 would typically have a diameter of about 0.3 inch. The length of the plunger should be such as to allow the non-head end of the plunger to seat in recess 14 and to allow the head end to be in proximity to the head of the jag member. In the case of a 50 caliber muzzleloader, the outer diameter of jag member 1 may be 0.46 inch with the internal diameter of chamber 9-0.38 inch. In the case of a 54 caliber muzzleloader, the outer diameter of jag member 1 may be 0.5 inch with the internal diameter of chamber 9-0.42 inch. The optimum outer diameter of jag member 1 may vary depending on the thickness of cleaning patch 11. One skilled in the art can readily determine the optimum dimensions by routine experimentation utilizing the guidelines given herein.

In the preferred embodiment of the invention as shown in FIGS. 4 and 5, the body portion 15 of the jag member between chamber 9 and means 4 for securing to a ram-rod is stepped-down, that is to say body portion 15 has a smaller diameter than chamber 9, but a larger diameter than means 4. The step-down may be in any convenient configuration, such as an immediate right angle step, a curved concave step as shown in FIG. 4, or a graduated inclined step as shown in FIG. 5. In these embodiments and referring to the typical dimensions for a cleaning device described above for the embodiment of FIGS. 4 and 5, a typical length for the stepped down portion of jag member 1 is about 0.2 inch longitudinally between the beginning of the step down and means 4. In the concave step down of FIG. 4, the radius of the curve may be about 0.1 inch. The optimum dimensions for a particular caliber gun may readily be determined by one of ordinary skill in this art utilizing the guidelines given herein.

In the embodiments of FIGS. 3A, 4 and 5, means 4 is preferably sized so as to fit directly into the appropriately sized ram-rod or for use without requiring the use of an adaptor. A typical ram-rod for use with a rifle, for example, has a 10-32 female thread. A typical ram-rod for use with a muzzle-loading shotgun, for example, has a 5/16-27 thread. Connecting means 4 would have an appropriately sized connecting male thread.

In the embodiment of FIG. 6, the body portion 15 of the jag member between chamber 9 and the means 4 for securing to a ram-rod is stepped down (as in the embodiments of FIGS. 4 and 5), but is configured in an essentially immediate right angle step as shown at 17. For ease of manufacture, the right angle step may be slightly curved (not shown), but it is preferred to be as rectangular as possible. This enhances retention of the cleaning material patch on the jag and also prevents the patch from binding up in the barrel. In this embodiment jag head 1 is provided with a plurality of inflexible ribs 18 which project beyond the chamber wall which assist in preventing slipping of the absorbent material off the jag head. Another advantage of the ribs on the jag head in this embodiment is that they allow the cleaning material patch to fall in the recesses between the ribs thereby allowing the patch to be moved more easily up and down in the barrel without binding. Member 19 may be any means for sealing the chamber from escape of cleaning fluid. When sealing member 19 is punctured or removed and cleaning material is, or is brought, into proximity with the chamber, the cleaning fluid is allowed or caused to contact the cleaning material. The cleaning material is positioned over the jag head 1 and the jag head with the saturated material is attached to a ram-rod and is inserted into the barrel of the gun. The jag member of this embodiment shown in FIG. 6 may be used with or without a plunger inserted through the cleaning material and into the chamber as described in the embodiment shown in FIGS. 3A, 3B and 3C herein. The plunger means may be employed whether or not it is used to puncture sealing member 19. After cleaning, the used jag head with cleaning material is discarded. The embodiment of FIG. 6 is particularly useful with a muzzleloader, but may be used with other guns as well, such as rifles and pistols.

Illustrative dimensions for the jag member according to the embodiment of FIG. 6 for use with a 50 caliber muzzleloader are as follows: The overall length of jag member 1 may be about 1.35 inches including the threaded ( 10/32) male portion 4. The diameter of threaded male portion 4 is about 0.35. The length of the jag member 1 without the threaded male portion 4 may be about 1 inch making the length of the threaded male portion about 0.3 inch. The jag member is cylindrical with an outer diameter of about 0.41 inch. Four concentric, circular ribs 18 which are preferably (but not necessarily) angled inwardly towards the opposite end of the jag from threaded member 4, as shown in the drawing, are spaced about 0.171 inch apart and project about 0.05 inch beyond the chamber wall. Such ribs may form a part of the chamber internally or comprise solid projections extending beyond the chamber. The spacing between the ribs is about 0.06 inch. These ribs preferably have sharp edges as shown in the drawing to better hold the cleaning patch. One flat rib with an is provided on the end of the chamber opposite the threaded portion to provide a surface for sealing the chamber as described previously herein. The internal diameter of chamber 19 may be about 0.41 inch. The chamber is open at its' end opposite from the threaded male portion 4 to allow filling with the desired type of cleaning fluid and sealing as described previously. Stepped down portion 15 of the chamber has a diameter of about 0.3 inch. These dimensions may be modified by one skilled in the art to fit different caliber muzzleloaders, rifles and pistols. Preferably, but not necessarily, a plunger as shown in FIG. 3A, but not shown in FIG. 6 is detachably molded to the threaded end of the jag which may be used to center the cleaning patch by positioning the plunger with cleaning patch attached to a plunger recess hole in the bottom of chamber 19 as shown in FIG. 3C, but not shown in FIG. 6. As is the case with the other embodiments, the plunger also serves as a cleaning patch holder in the event that the cleaning patch should slip off the jag. Use of a plunger as described may be particularly useful for jags used to clean muzzleloaders since muzzleloaders have only one open end. The other end contains a breech plug so if the cleaning patch were to disengage, it would be difficult to remove without the plunger.

In the embodiment of FIG. 7, the body portion 15 of the jag member between the chamber and the means 4 for securing to a ram-rod is stepped down (as in the embodiments of FIGS. 4 and 5), as shown at 17. The step-down in this embodiment need not be at a right angle as shown in FIG. 6 but may comprise any step-down configuration such as a right angle, a bevel, or a curved configuration. The configuration shown in FIG. 7 is curved. In this embodiment jag head 1 is provided with a plurality of thin flexible ribs or fins 20 which serve to retain the cleaning patch on the jag. The flexible ribs also allows the user of the jag to clean most shotguns with different size chokes. Some shotgun barrel bores have a taper (larger) from where the shell goes in to the muzzle (smaller). Other shotguns do not have a tapered bore, but incorporate a choke tube system. This system makes the muzzle end smaller. With the flexible rib or fin design of this embodiment, the flexible ribs will flex back when forced into the small end of the muzzle and then flex back as the bore gets larger. This flexing action keeps constant pressure of the cleaning material for a thorough cleaning. Alternatively, the choke may be unscrewed from the barrel and the barrel and the choke cleaned with the same jag. As in the embodiments of FIGS. 3A, 3B, 3C, 4, 5 and 6, the jag chamber is filled with cleaning fluid and sealed to prevent premature escape of cleaning fluid. Use of this embodiment of the invention with respect to sealing the chamber and allowing the cleaning fluid to contact the cleaning material is as described in the embodiments of FIG. 3A, 3B, 3C, 4, 5 and 6 and, as stated in the description of the use of the embodiment of FIG. 6, may be used with or without a plunger. After cleaning, the used jag head with cleaning material attached is discarded.

Illustrative dimensions for the jag member according to the embodiment of FIG. 7 for use with a 12 gauge shotgun are as follows: The overall length of jag member 1 may be about 1.2 inches including the threaded ( 10/32) male portion 4. The length of the jag member 1 without the threaded male portion 4 may be about 0.95 inch making the length of the threaded male portion about 0.25 inch. The diameter of the threaded male portion is about 0.311 inch. The jag member is cylindrical with an outer diameter of about 0.5 inch. Four flexible concentric circular fins 20 are provided which are spaced about 0.15 inch apart. The thickness of the fins is about 0.02 inch and the diameter of the fins is about 0.76 inch. The internal diameter of chamber 19 may be about 0.45 inch. Stepped down portion 15 of the chamber has a diameter of about 0.4 inch.

One advantage of the stepped-down body portion 15 of the jag member in the embodiments of FIGS. 1A, 4,5,6 and 7 is that it provides stabilization of the head of the jag member when connecting means 4 is sized to fit directly into the receiving end of a ram-rod. Preferably, jag member 1 should be seated against the ram-rod (not shown) so that undue force is not exerted against connecting means 4 which might otherwise cause means 4 to break. Without the stepped-down body portion, the resulting larger head portion of the jag member would create more friction on the jag member when it is forced down the gun barrel.

Another function of the stepped-down body portion 15 is to allow some of the patch material to be squeezed into the stepped-down area. This serves to prevent the patch material from slipping off the larger diameter portion (the head) of the jag member when the jag member is pulled out of the gun barrel.

I claim:

1. A disposable cleaning device for a gun barrel comprising a jag member which is adapted to contain a cleaning fluid for said gun barrel, said jag member having means at one end for securing to a ram-rod or cable and further having means for allowing said cleaning fluid to contact an absorbent cleaning material.

2. The disposable cleaning device according to claim 1 in which said means for allowing said cleaning fluid to contact said absorbent cleaning material comprises an absorbent cleaning material containing said cleaning fluid secured to said jag member which absorbent cleaning material is sealed to the atmosphere with a readily removable material.

3. The disposable cleaning device according to claim 2 in which the absorbent cleaning material surrounds said jag member and said readily removable material comprises a plastic material.

4. The disposable cleaning device according to claim 3 in which the means for securing to a ram-rod or cable comprises a reduced diameter portion of the jag member which is threaded so as to screw into a female threaded end of the ram-rod or cable.

5. The disposable cleaning device according to claim 1 in which said means for allowing said cleaning fluid to contact said absorbent cleaning material comprises rupturable means within the jag to contain said cleaning material, means for cleaning fluid to escape from the jag upon rupture of said rupturable means and an absorbent cleaning material secured to the outer surface of the jag member so as to allow, upon rupture of said rupturable means, cleaning fluid to escape from said rupturable means and be absorbed by said absorbent cleaning material.

6. The disposable cleaning device according to claim 5 in which said absorbent cleaning material surrounds the jag member.

7. The disposable cleaning device according to claim 6 in which said rupturable means within the jag comprises a rupturable capsule.

8. The disposable cleaning device according to claim 7 in which said rupturable capsule is constructed of glass.

9. The disposable cleaning device according to claim 5 in which said jag member is in open communication with said absorbent cleaning material.

10. The disposable cleaning device according to claim 9 in which said open communication comprises perforations in the jag member.

11. The disposable cleaning device according to claim 9 in which said open communication comprises elongated openings in the sidewalls of the jag member.

12. The disposable cleaning device according to claim 5 in which said jag member is constructed of a flexible plastic material.

13. The disposable cleaning device according to claim 12 in which said absorbent cleaning material surrounds the jag member; in which said rupturable means within the jag comprises a rupturable capsule; and in which said jag member is in open communication with said absorbent cleaning material.

14. The disposable cleaning device according to claim 13 in which said rupturable capsule is constructed of glass and in which said open communication comprises elongated openings in the sidewalls of the jag member.

15. The disposable cleaning device according to claim 1 in which the means for allowing said cleaning fluid to contact absorbent cleaning material comprises a chamber containing said cleaning fluid in the end of the jag member opposite the means for securing said jag member to a ram-rod or cable, and a rupturable or removable member at the end of said chamber so that, upon rupture or removal of said member, cleaning fluid escapes from the chamber and contacts absorbent cleaning material which is, or which is brought, in proximity to the end of said chamber.

16. The disposable cleaning device according to claim 15 in which said chamber contains a recess within and at the bottom of said chamber of a shape and dimension to provide a seat for the end of a plunger.

17. The disposable cleaning device according to claim 16 in which a plunger having a head portion which is larger than the body portion of the plunger is removably attached to the end of the jag member which comprises the means for securing said jag member to a ram-rod or cable.

18. The disposable cleaning device according to claim 15 which includes means for attaching absorbent cleaning material to said chamber.

19. The disposable cleaning device according to claim 18 in which said means for attaching absorbent cleaning material to said chamber comprises a plunger, having a head portion which is larger than the body of said plunger, passing through absorbent cleaning material and into said chamber.

20. The disposable cleaning device according to claim 19 in which said plunger has a recess below said head portion to engage said absorbent cleaning material.

21. The disposable cleaning device according to claim 19 in which said plunger is seated into a recess within and in the bottom of said chamber.

22. The disposable cleaning device according to claim 15 in which said means for securing to a ram-rod or cable comprises a reduced diameter portion of the jag member which is threaded so as to screw into a female threaded end of the ram-rod or cable, and in which the body of said jag member between the chamber and said means for securing to a ram-rod or cable has a smaller diameter than said chamber but a larger diameter than said means for securing to a ram-rod or cable.

23. The disposable cleaning device according to claim 22 in which the smaller and larger diameter sections of the jag member merge in essentially a right angle step.

24. The disposable cleaning device according to claim 22 in which said chamber contains a recess within and in the bottom of said chamber of a shape and dimension to provide a seat for the end of a plunger.

25. The disposable cleaning device according to claim 24 in which a plunger having a head portion which is larger than the body portion of said plunger is removably attached to the end of the jag member which comprises the means for securing said jag member to a ram-rod or cable.

26. The disposable cleaning device according to claim 22 which includes means for attaching absorbent cleaning material to said chamber.

27. The disposable cleaning device according to claim 26 in which said means for attaching absorbent cleaning material to said chamber comprises a plunger, having a head portion which is larger than the body portion of said plunger, passing through absorbent cleaning material and into said chamber.

28. The disposable cleaning device according to claim 27 in which said plunger has a recess below said head portion to engage said absorbent cleaning material.

29. The disposable cleaning device according to claim 27 in which said plunger is seated into a recess within and in the bottom of said chamber.

30. The disposable cleaning device according to claim 22 in which the outer surface of the chamber contains means to prevent or retard absorbent cleaning material from slipping off said chamber when said device is used to clean a gun barrel.

31. The disposable cleaning device according to claim 30 in which such means comprises a distressed surface on the outer surface of said chamber.

32. The disposable cleaning device according to claim 30 in which such means comprise a plurality of circular concentric flexible fins extending outwardly from said chamber.

33. The disposable cleaning device according to claim 30 in which such means comprise a plurality of circular concentric inflexible ribs extending outwardly from said chamber.

35. The disposable cleaning device according to claim 33 in which said chamber contains a recess within and in the bottom of said chamber of a shape and dimension to provide a seat for the end of a plunger.

36. The disposable cleaning device according to claim 35 in which a plunger having a head portion which is larger than the body portion of said plunger is removably attached to the end of the jag member which comprises the means for securing said jag member to a ram-rod or cable.

37. The disposable cleaning device according to claim 36 which includes means for attaching absorbent cleaning material to said chamber.

38. The disposable cleaning device according to claim 37 in which said plunger has a recess below said head portion to engage said absorbent cleaning material.

39. The disposable cleaning device according to claim 39 in which said plunger is seated into a recess within and in the bottom of said chamber.
